(19) United States
(12) Patent Application Publication
(10) Pub. No.: US 2013/0066679 A1
(43) Pub. Date: Mar. 14, 2013

(54) USING EVENTS DATA

(71) Applicants: David F. WELCH, Atherton, CA (US); Josue I. KURI, Sunnyvale, CA (US); Daniel REIF, Redwood City, CA (US)

(72) Inventors: David F. WELCH, Atherton, CA (US); Josue I. KURI, Sunnyvale, CA (US); Daniel REIF, Redwood City, CA (US)

(73) Assignee: INFINERA CORPORATION, Sunnyvale, CA (US)

(21) Appl. No.: 13/232,795

(22) Filed: Sep. 14, 2011

(51) Int. Cl. G06Q 10/04

(52) U.S. Cl. 705/7.31

(57) ABSTRACT

A computer device receives a list of events, and generates possible outcomes of the events. Each one of the possible outcomes indicates which ones of the events occur and which ones of the events do not occur. The computer device receives a request for forecast information for an item associated with two or more of the events. The computer device further retrieves data, from the possible outcomes, for the item. The computer device generates the forecast, for the item, based on the data. The computer device also uses the forecast to generate a plan to provide or to provide the item or a product associated with the item.

### BACKGROUND

Currently, businesses (e.g., manufacturers) are able to make and/or receive forecasts of possible sales (i.e., events) of items (e.g., products). However, the businesses are unable to use the forecasts of the possible sales to effectively plan for procurement of individual items, or of parts for the individual items, before the possible sales occur. For example, a business may not be able to accurately communicate, based on the forecasts of the possible sales, to a supplier of a particular item how much of the particular item may be required if the possible sales occur. As a result, the business may order and/or the supplier may produce too much or too little of the particular item. The business and/or the supplier waste resources when too much of the particular item is produced. Conversely, when too little of the particular item is produced, the business may incur additional expenses, associated with ordering and/or producing the particular item within a short time frame (e.g., when it becomes clear that not enough of the particular item was ordered), and/or lose sales opportunities.

### SUMMARY

According to one implementation a method, performed by a computer device, may include receiving information about events. Each event, of the events, may be associated with one or more of a plurality of items that occur when the event occurs. The method may further include: generating possible outcomes of the events based on the information; receiving a request for a forecast for only one or more selected items of the plurality of items; retrieving data, for only the one or more selected items, from the possible outcomes; generating the forecast for the one or more selected items based on the data; and providing the forecast to an entity associated with the events or to a supplier of the one or more selected items.

According to another implementation, a device may include a memory and a processor. The memory may store instructions. The processor may execute one or more of the instructions to: receive information associated with a plurality of events; generate possible outcomes of the plurality of events based on the information; receive a request for a forecast for one or more selected items; generate the forecast, for only the one or more selected items, based on the data; and use the forecast to generate a plan to provide the one or more selected items. A first event, of the plurality of events, may include a first item and a second item. A second event, of the plurality of events, may include the first item and one or more third items. The one or more selected items may include a selection of the first item.

According to yet another implementation, one or more non-transitory computer-readable media may include instructions, which when executed by one or more processors of a computing device, cause the one or more processors to: receive a list of events; generate possible outcomes of the events; receive a request for forecast information for an item associated with two or more of the events; retrieve data, from the possible outcomes, for the item; generate the forecast, for the item, based on the data; and use the forecast to generate a plan to provide or to provide the item or a product associated with the item. Each one of the possible outcomes may indicate which ones of the events occur and which ones of the events do not occur.

### BRIEF DESCRIPTION OF THE DRAWINGS

The accompanying drawings, which are incorporated in and constitute a part of this specification, illustrate one or more implementations described herein and, together with the description, explain these implementations. In the drawings:

FIG. 1 is a diagram of an example environment in which systems and/or methods described herein may be implemented;

FIG. 2 is a diagram of example components of one or more of the devices of FIG. 1;

FIG. 3 is a diagram of an example data structure that stores information about events;

FIG. 4 is a diagram of an example data structure that stores information about items of an event;

FIGS. 5A and 5B are diagrams of example data structures that store outcome information that is generated based on simulated outcomes of the events;

FIGS. 6A-6C are diagrams of example statistical representations that are generated for particular item(s); and

FIG. 7 is a flowchart of an example process for using events data to provide information about particular item(s).

### DETAILED DESCRIPTION

The following detailed description refers to the accompanying drawings. The same reference numbers in different drawings may identify the same or similar elements.

An entity may refer to any business organization or person that acquires items (e.g., products or parts) from a supplier in order to make sales (e.g., of the items or products manufactured by using the items) to customers. A supplier may refer to any organization or person that provides items (e.g., products and/or parts) to an entity. A customer may refer to any organization or person that purchases items from an entity in a sale. In one example, an entity may include a distributor, a supplier may include a manufacturer, and a customer may include a retail store. In another example, an entity may include a manufacturer, a supplier may include a raw materials dealer, and a customer may include a distributor or a retail store.

An event may represent a possible occurrence. One event may be statistically independent from another event. An event may be associated with a set of items. For example, an individual event may represent a possible sale of items to a customer during a particular period of time. Each one of the items may represent a different product or a different part for a product. Two or more events may be associated with one or more of the same items.

When an event occurs, all items associated with (e.g., included in/part of) the event may occur. Conversely, when an event does not occur, no items associated with (e.g., included in) the event may occur.

In some implementations, an event may be defined by a probability (e.g., 50%), qualitative attributes, and a set of items. The qualitative attributes of an event may include, for example, an event identifier (e.g., an event name) of the event, a fiscal period associated with the event, a customer associated with the event, etc. Each item, in a set of items, may be defined by qualitative attributes and quantitative attributes. The qualitative attributes of an item may include, for example, an item identifier (e.g., an item name) of the item, a category (e.g., a product category) associated with the item, etc. The quantitative attributes of an item may include, for example, a quantity of units of the item to be acquired by a customer if the event occurs, costs (e.g., to a business) associated with item, prices (e.g., to a customer) associated with the item, etc.

One or more implementations, described herein, may allow a computer device to use events data to provide information about particular items. For example, a computer device, of an entity (e.g., a business), may receive a list of events. The list of the events may include a probability for each one of the events on the list. The computer device may generate a number of possible outcomes based on the list of the events by using the probabilities associated with the events. A possible outcome may indicate whether each particular event, included in the list of the events, is predicted to occur.

Thereafter, the computer device may receive a request for forecast information for a particular item. The computer device may receive the request from, for example, a server of a supplier of the particular item. The computer device may retrieve data about the particular item from the stored possible outcomes. The computer device may generate statistical representations for the particular item based on the retrieved data. The statistical representations may, for example, indicate a range of quantities, of the particular item, or one or more different ranges/quantities, of the particular item, that are most likely to be needed by the entity.

As a result, the entity, that operates the computer device, is better able to control a supply chain for the particular item. In one implementation, the entity may use the statistical representations to manufacture, or place an order for, the particular item based on the statistical representations. In another implementation, the computer device may provide the statistical representations to the server of the supplier. The supplier (e.g., the server of the supplier) may plan to provide, manufacture, and/or provide the particular item to the entity based on the statistical representations. In yet another implementation, the computer device may provide the retrieved data to the server of the supplier or a different computer device. The server or the different computer device may generate the statistical representations based on the retrieved data.

### Example Environment

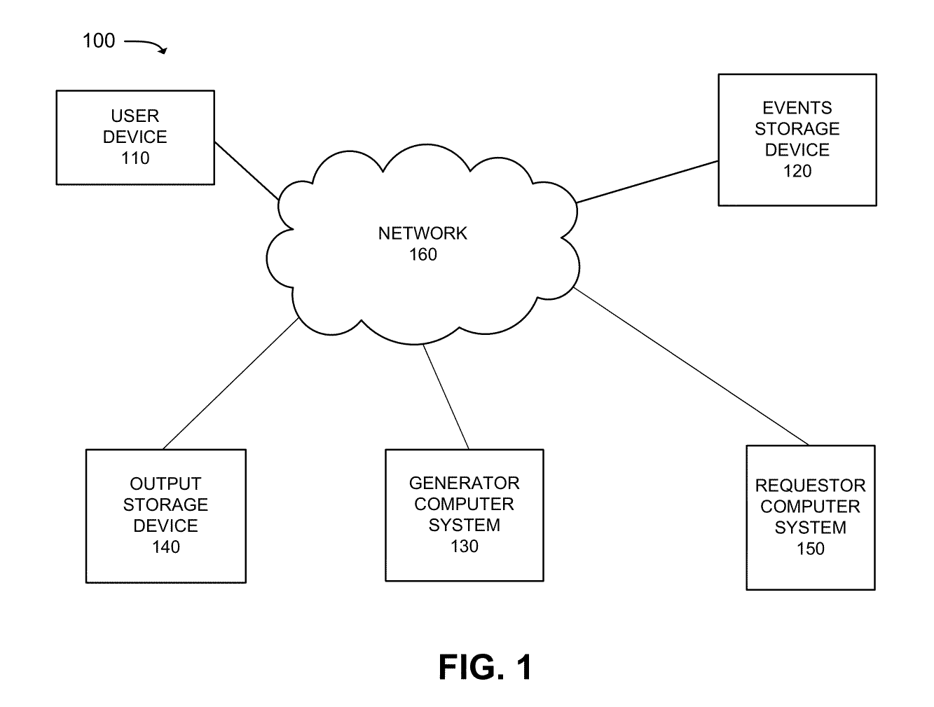

FIG. 1 is a diagram of an example environment 100 in which systems and/or methods described herein may be implemented. As shown in FIG. 1, environment 100 may include a user device 110, an events storage device 120, a generator computer system 130, an output storage device 140, a requestor computer system 150, and a network 160. The number of devices and/or networks, illustrated in FIG. 1, is provided for explanatory purposes only. In practice, environment 100 may include additional devices/networks, fewer devices/networks, different devices/networks, or differently arranged devices/networks than are shown in FIG. 1. In some implementations, one or more of the devices of environment 100 may perform one or more functions described as being performed by another one or more of the devices of environment 100.

Furthermore, two or more of the devices, of FIG. 1, may be implemented within a single device, or a single device may be implemented as multiple, distributed devices. Also, devices of environment 100 may interconnect via wired and/or wireless connections. In other words, any two devices, of environment 100, may communicate via a wired connection, a wireless connection, or a combination of a wired connection and a wireless connection.

User device 110 may include any computation or communication device, such as a communication device that is capable of communicating with events storage device 120. For example, user device 110 may take the form of a computer, including a personal computer, a laptop, a handheld computer, a smart phone, a mobile telephone device, a personal digital assistant (PDA), etc., or any device capable of transmitting data to a computer. An employee (e.g., a salesperson) of an entity may use user device 110 to enter information about one or more possible events. User device 110 may transmit the information to events storage device 120.

Events storage device 120 may include any storage device, such as a storage device that is capable of storing information received from user device 110 and/or one or more other user devices. In one implementation, events storage device 120 may take the form of a single server device or a collection of multiple server devices and/or computer systems. Events storage device 120 may connect to user device 110 and/or generator computer system 130 via network 160. In another implementation, events storage device 120 may be a part of user device 110 or generator computer system 130.

Events storage device 120 may receive events information about one or more events from user device 110. Events storage device 120 may store the events information in a database and/or in one or more other types of data structures that are used to store data. In one implementation, event storage device 120, may receive, from generator computer system 130, a request for the events information, or a portion of the events information. In response to the request, events storage device 120 may retrieve the events information, and may provide the events information, or the portion of the events information, to generator computer system 130. In another implementation, generator computer system 130 may retrieve the events information directly from the data structures stored in events storage device 120.

Generator computer system 130 may include any computation or communication device, such as a communication device that is capable of communicating with events storage device 120, output storage device 140, and/or requestor computer system 150. In one implementation, generator computer system 130 may represent a single server device or a collection of multiple server devices and/or computer systems. In another implementation, generator computer system 130 may take the form of one or more computers, including a personal computer.

Generator computer system 130 may receive/retrieve events information from events storage device 120. Generator computer system 130 may process the events information by, for example, generating possible outcomes based on the events information. In one implementation, generator computer system 130 may transmit the generated possible outcomes to output storage device 140. In another implementation, generator computer system 130 may include output storage device 140, and may directly store the generated possible outcomes in output storage device 140.

Generator computer system 130 may further receive a request for forecast information for one or more particular items from requestor computer system 150. Generator computer system 130 may retrieve data for the one or more particular items from output storage device 140. Generator computer system 130 may generate statistical representations for the one or more particular items. The statistical representations may provide the requested forecast information. In one implementation, generator computer system 130 may transmit the statistical representations, or information based on the statistical representations, to requestor computer system 150. In another implementation, generator computer system 130 may perform an action based on the statistical representations. The action may include, for example, placing an order from a supplier for the one or more particular items and/or prompting the manufacturing of the one or more particular items.

Output storage device 140 may include any storage device, such as a storage device that is capable of storing information received from generator computer system 130. In one implementation, output storage device 140 may take the form of a single server device or a collection of multiple server devices and/or computer systems. Output storage device 140 may connect to generator computer system 130 via network 160. In another implementation, output storage device 140 may be a part of, or directly connected to, generator computer system 130.

As discussed above, output storage device 140 may receive possible outcomes information, associated with events, from generator computer system 130. Output storage device 140 may store the possible outcomes information in a database and/or in one or more other types of data structures used to store data. In one implementation, output storage device 140, may receive, from generator computer system 130, a request for a portion of the possible outcomes information that is associated with one or more particular items. In response to the request, output storage device 140 may retrieve the requested portion of the possible outcomes information, and may provide the requested portion of the possible outcomes information to generator computer system 130. In another implementation, generator computer system 130 may retrieve the outcomes information directly from the data structures stored in output storage device 140.

Requestor computer system 150 may include any computation or communication device, such as a communication device that is capable of communicating with generator computer system 130. In one implementation, requestor computer system 150 may represent a single server device or a collection of multiple server devices and/or computer systems. In another implementation, requestor computer system 150 may take the form of one or more computers, including a personal computer. In yet another implementation, requestor computer system 150 may represent a computer terminal that is part of and/or directly connected to generator computer system 130 or user device 110. A third party (e.g., a supplier) or an employee of an operator of generator computer system 130 may operate requestor computer system 150.

Requestor computer system 150 may transmit, to generator computer system 130, a request for forecast information associated with one or more particular items. In response, requestor computer system 150 may receive the requested forecast information (e.g., in the form of one or more statistical representations). Requestor computer system 150 may use the requested forecast information to plan to provide, to manufacture, and/or to provide the one or more particular items to the operator.

Network 160 may include a single network, multiple networks of a same type, or multiple networks of different types. For example, network 160 may include one or more of a direct connection between devices, a local area network (LAN), a wide area network (WAN) (e.g., the Internet), a metropolitan area network (MAN), a wireless network (e.g., a general packet radio service (GPRS) network), a telephone network (e.g., a Public Switched Telephone Network or a cellular network), a subset of the Internet, an ad hoc network, or any combination of the aforementioned networks.

### Example Device

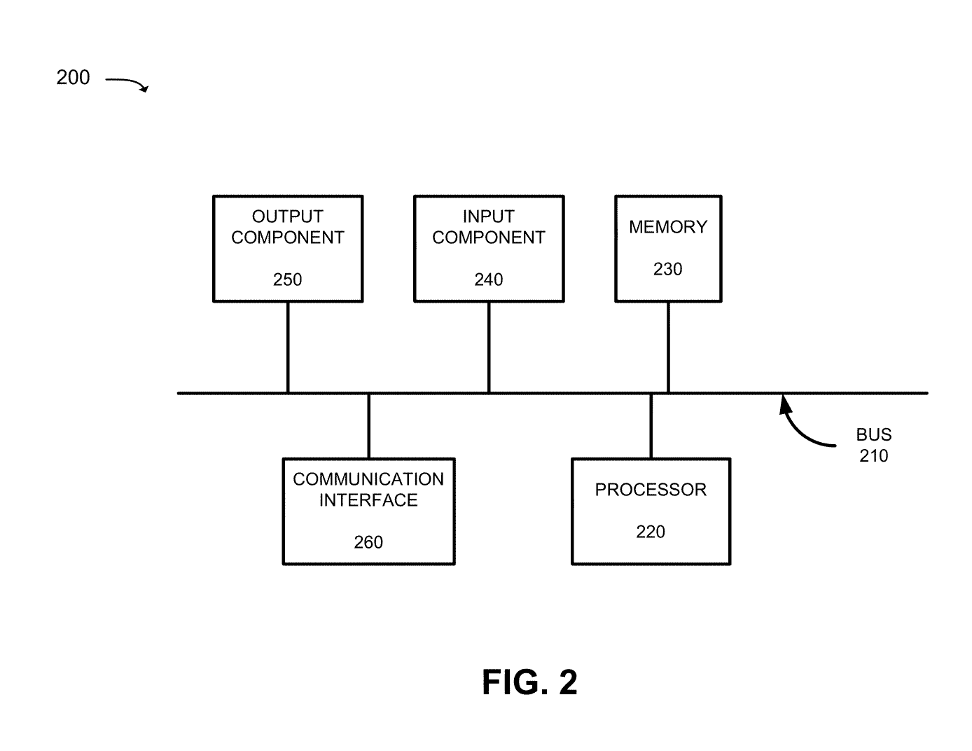

FIG. 2 is a diagram of example components of a device 200. Device 200 may correspond to user device 110, events storage device 120, generator computer system 130, output storage device 140, and requestor computer system 150. Alternatively, or additionally, each of user device 110, events storage device 120, generator computer system 130, output storage device 140, and requestor computer system 150 may include one or more devices 200 and/or one or more portions of devices 200.

Device 200 may include a bus 210, a processor 220, a memory 230, an input component 240, an output component 250, and a communication interface 260. Although FIG. 2 shows example components of device 200, in other implementations, device 200 may contain fewer components, additional components, different components, or differently arranged components than depicted in FIG. 2. For example, device 200 may include one or more switch fabrics instead of, or in addition to, bus 210. Additionally, or alternatively, one or more components of device 200 may perform one or more tasks described as being performed by one or more other components of device 200.

Bus 210 may include a path that permits communication among the components of device 200. Processor 220 may include a processor, a microprocessor, or processing logic (e.g., an ASIC or FPGA) that may interpret and execute instructions. Memory 230 may include any type of dynamic storage device that may store information and instructions, for execution by processor 220, and/or any type of non-volatile storage device that may store information for use by processor 220.

Input component 240 may include a mechanism that permits a user to input information to device 200, such as a keyboard, a keypad, a button, a switch, etc. Output component 250 may include a mechanism that outputs information to the user, such as a display, a speaker, one or more light emitting diodes (LEDs), etc. Communication interface 260 may include any transceiver-like mechanism that enables device 200 to communicate with other devices and/or systems via wireless communications (e.g., radio frequency, infrared, and/or visual optics, etc.), wired communications (e.g., conductive wire, twisted pair cable, coaxial cable, transmission line, fiber optic cable, and/or waveguide, etc.), or a combination of wireless and wired communications. For example, communication interface 260 may include mechanisms for communicating with another device or system via a network, such as network 160. In one alternative implementation, communication interface 260 may be a logical component that includes input and output ports, input and output systems, and/or other input and output components that facilitate the transmission of data to other devices.

Device 200 may perform these operations in response to processor 220 executing software instructions contained in a computer-readable medium, such as memory 230. A computer-readable medium may be defined as a non-transitory memory device. A memory device may include space within a single physical memory device or spread across multiple physical memory devices. The software instructions may be read into memory 230 from another computer-readable medium or from another device. The software instructions contained in memory 230 may cause processor 220 to perform processes described herein. Alternatively, hardwired circuitry may be used in place of or in combination with software instructions to implement processes described herein. Thus, implementations described herein are not limited to any specific combination of hardware circuitry and software.

### Example Data Structures

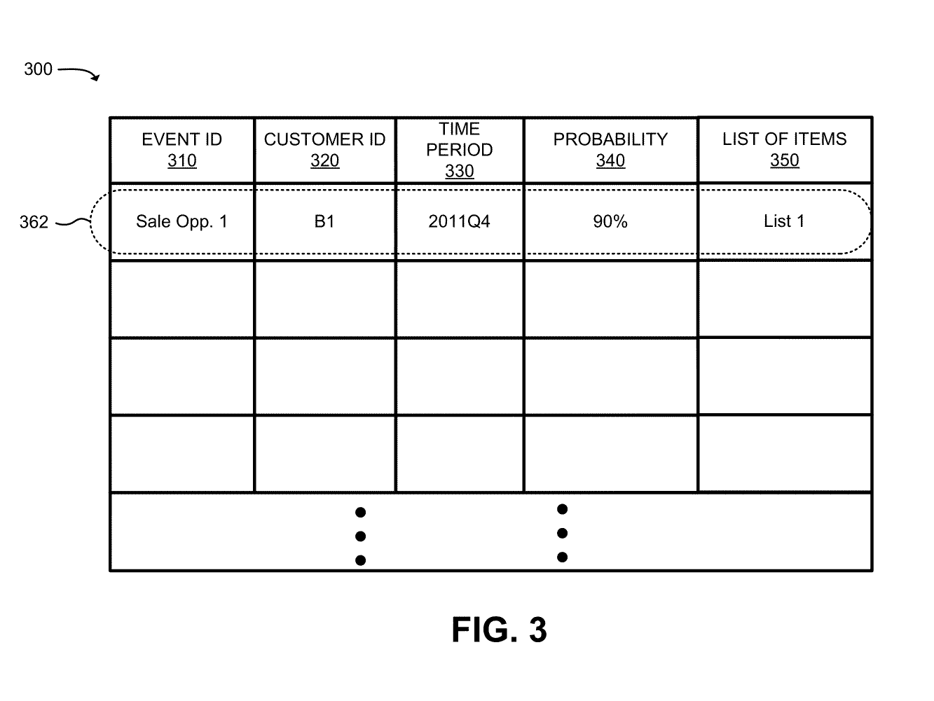

FIG. 3 is a diagram of an example data structure 300 that stores information about events. In one implementation, events storage device 120 may generate data structure 300 based on information received from user device 110 and/or one or more other devices. In another implementation, user device 110 may transmit data structure 300, which includes information about one or more events, to events storage device 120. Events storage device 120 may store data structure 300. Events storage device 120 may transmit data structure 300, as a list, or as part of a list, of events, to generator computer system 130. Generator computer system 130 may process data structure 300 to generate possible outcomes of events identified in data structure 300.

As shown in FIG. 3, data structure 300 may include a collection of fields, such as an event identifier (ID) field 310, a customer ID field 320, a time period field 330, a probability field 340, and a list of items field 350. Data structure 300 includes fields 310-350 for explanatory purposes. In practice, data structure 300 may include additional fields, fewer fields, different fields, and/or differently arranged fields than are described with respect to data structure 300.

Event ID field 310 may store information that uniquely identifies a particular event, defined in data structure 300, from other events. For example, the particular event may represent a sales opportunity (e.g., a possible sale of item(s) to a customer) of a seller. Event ID field 310 may store a name assigned to the particular event or any other combination of characters that are used to uniquely identify the particular event.

Customer ID field 320 may store information that identifies another party that is involved in the particular event if the particular event occurs. For example, the other party may include a customer that will buy items from the seller if the sales opportunity occurs. Customer ID field 320 may store a name of the other party or any other combination of characters that are used to identify the other party.

Time period field 330 may store information that identifies a period of time during which the particular event may occur. For example, the period of time may be represented by a fiscal period. Alternatively, the period of time may represent any other period of time defined by a user. Probability field 340 may store information that identifies a probability of the particular event occurring. For example, the probability may be represented by a particular percentage.

List of items field 350 may store information about one or more items associated with the particular event. For example, the items may include products that may be sold to the customer, as part of the particular event, if the sales opportunity, represented by the event, occurs. In one implementation, list of items field 350 may store a different data structure or a reference to the different data structure. The different data structure may include information about the items.

Ellipse 362 may correspond to one event of the events for which information is included in data structure. For example, as shown in ellipse 362, information about the one event may include, an identifier (e.g., Sales Opp. 1) of a possible sales opportunity, an identifier (e.g., B1) of a possible buyer, an identifier (e.g., 2011Q4) of a particular fiscal period (e.g., the fourth quarter of year 2011), a percentage (e.g., 90%) that indicates a probability of the possible sales opportunity occurring, and a list of items (e.g., List 1). The list of items may include, or refer to, a data structure that stores information about items of the event.

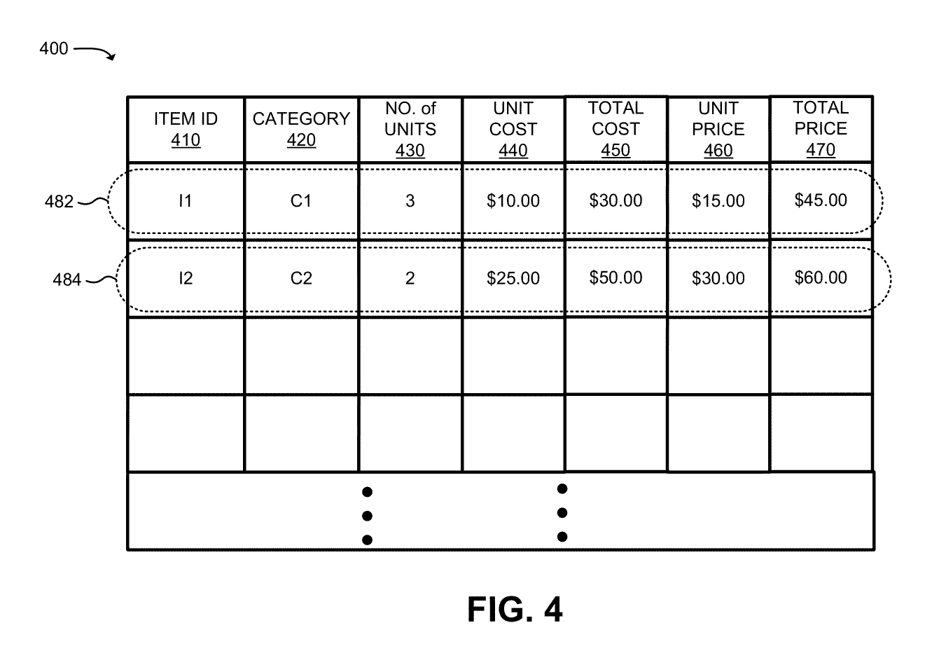

FIG. 4 is a diagram of an example data structure 400 that stores information about items of an event. In one implementation, events storage device 120 may generate data structure 400, while generating (e.g., as part of) data structure 300, based on information received from user device 110 and/or one or more other devices. In another implementation, user device 110 may transmit data structure 400, as part of data structure 300, to events storage device 120. Events storage device 120 may store data structure 400 in data structure 300 or in association with an event of data structure 300.

As shown in FIG. 4, data structure 400 may include a collection of fields, such as an item ID field 410, a category field 420, a number (no.) of units field 430, a unit cost field 440, a total cost field 450, a unit price field 460, and a total price field 470. Data structure 400 includes fields 410-470 for explanatory purposes. In practice, data structure 400 may include additional fields, fewer fields, different fields, and/or differently arranged fields than are described with respect to data structure 400.

Item ID field 410 may store information that uniquely identifies a particular item, of an event, from other items. For example, the particular item may represent a product that may be sold as part of an event. Item ID field 410 may store a name assigned to the particular item or any other combination of characters (e.g., a part ordering number (PON)) that are used to uniquely identify the particular item.

Category field 420 may store information that identifies a category associated with the particular item. In one example, when information in item ID field 410 identifies a particular car, corresponding information in category field 420 may identify vehicles. In another example, when information in item ID field 410 identifies a particular table, corresponding information in category field 420 may identify furniture. Category field 420 may store a name used for a category or any other combination of characters that are used to identify the category.

Number of units field 430 may store information that identifies a quantity of units of the particular item that will be sold if the event occurs. For example, number of units field 320 may store a numerical value (i.e., a number) that represents the quantity.

Unit cost field 440 may store information that identifies a cost of a unit of the particular item to an entity, which may sell the particular item as part of the event. The entity may incur the cost of the unit when the entity buys the particular item or parts, for the particular item, from a supplier and/or when the entity produces the particular item. For example, unit cost field 440 may store a monetary value, in a particular type of currency, that represents the cost of the unit.

Total cost field 450 may store information that identifies a total cost of all of the units of the particular item to the entity if the event occurs. For example, total cost field 450 may store a result of multiplying the corresponding numerical value, in number of units field 430, and the corresponding monetary value, in unit cost field 440.

Unit price field 460 may store information that identifies a unit price at which the entity may sell a unit of the particular item to a customer as part of the event. For example, unit price field 460 may store a monetary value, in the particular type of currency, that represents the price of the unit.

Total price field 470 may store information that identifies a total price at which the entity will sell all of the units of the particular item to the customer as part of the event if the event occurs. For example, total price field 470 may store a result of multiplying the corresponding numerical value, in number of units field 430, and the corresponding monetary value, in unit price field 460.

Each one of ellipses 482 and 484 may correspond to a different item of a particular event. For example, information associated with a first item of the particular event may include, as shown in ellipse 482, an identifier (e.g., I1) associated with the first item, a first category (e.g., C1) associated with the first item, a quantity of units (e.g., 3) that may be sold of the first item, a unit cost (e.g., $10.00) of each one of the units of the first item, a total cost (e.g., $30.00) of all of the units of the first item, a unit price (e.g., $15.00) of each one of the units of the first item, and a total price (e.g., $45.00) of all of the units of the first item.

Information associated with a second item of the particular event may include, as shown in ellipse 484, an identifier (e.g., I2) associated with the second item, a second category (e.g., C2) associated with the second item, a quantity of units (e.g., 2) that may be sold of the second item, a unit cost (e.g., $25.00) of each one of the units of the second item, a total cost (e.g., $50.00) of all of the units of the second item, a unit price (e.g., $30.00) of each one of the units of the second item, and a total price (e.g., $60.00) of all of the units of the second item.

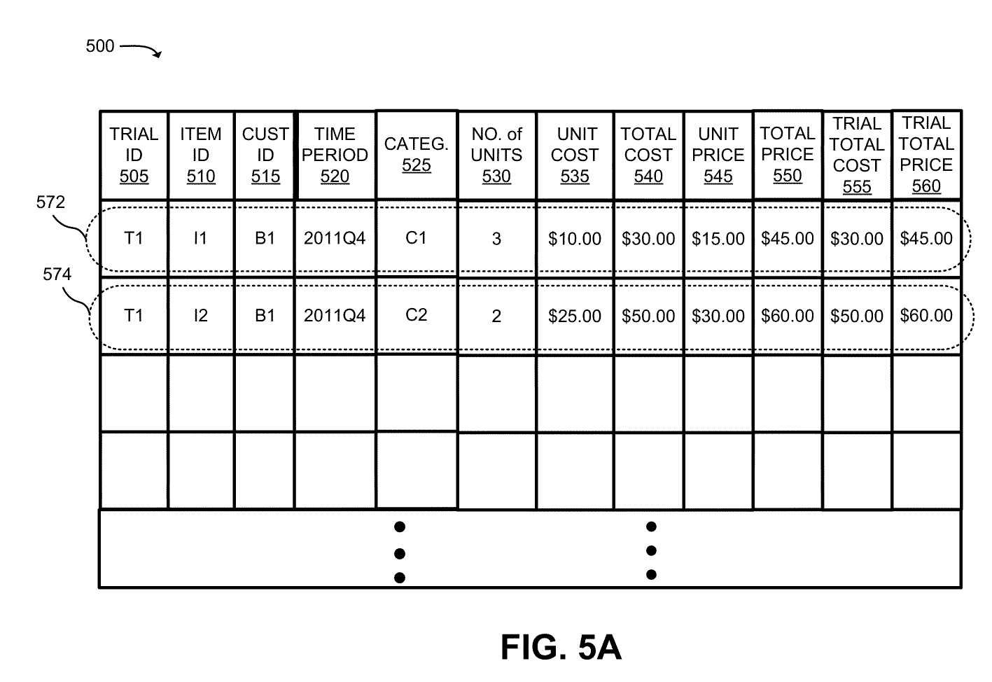

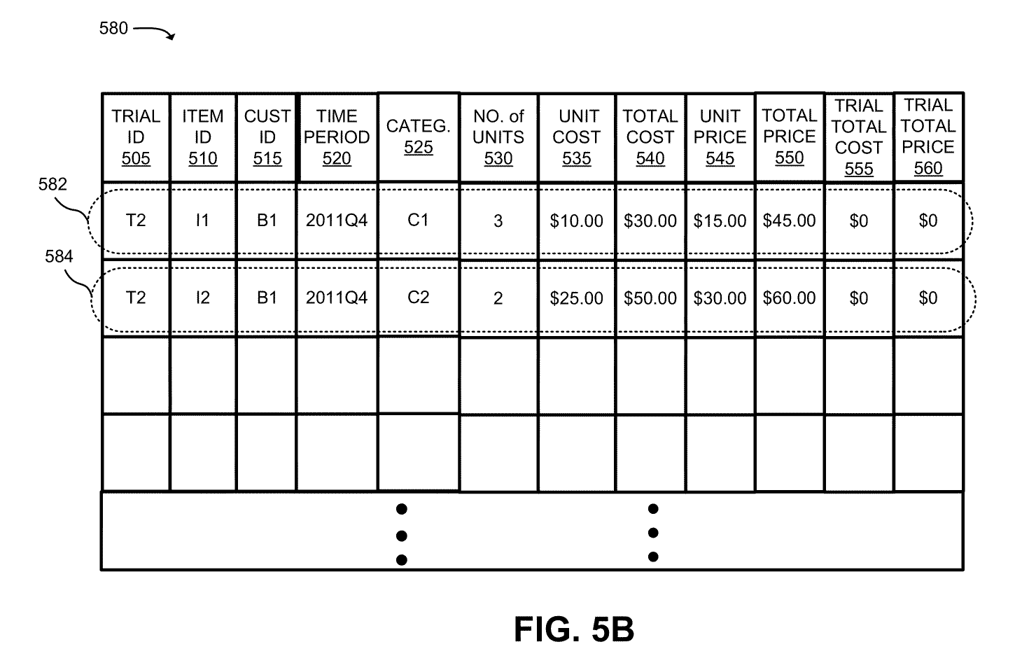

FIGS. 5A and 5B are diagrams of example data structures that store outcome information that is generated based on simulated outcomes of the events. In an example implementation, generator computer system 130 may generate a particular number of possible outcomes based on the list of events. Each one of the possible outcomes may include one or more events, from the list of events, that occur, and/or one or more other events, from the list of events, that do not occur.

For example, a list of events may include a first event, a second event, and a third event. Generator computer system 130 may generate a first possible outcome and a second possible outcome. The first possible outcome may indicate that the first event occurred, that the second event occurred, and that the third event did not occur. The second possible outcome may indicate that the first event occurred, that the second event did not occur, and that the third event did not occur.

FIG. 5A illustrates a data structure 500, which is a portion of an example outcome, for items of an event that occurs. Generator computer system 130 may generate data structure 500 as part of generating the example outcome. Generator computer system 130 may transmit/store the example outcome, including data structure 500, to/in output storage device 140. Thereafter, generator computer system 130 may retrieve data structure 500, or portions of/information from data structure 500, as part of data associated with one or more particular items. Generator computer system 130 may use the data to generate statistical representations for the one or more particular items.

As shown in FIG. 5A, data structure 500 may include a collection of fields, such as a trial ID field 505, an item ID field 510, a customer ID field 515, a time period ID field 520, a category field 525, a number of units field 530, a unit cost field 535, a total cost field 540, a unit price field 545, a total price field 550, a trial total cost field 555, and a trial total price field 560. Data structure 500 includes fields 505-560 for explanatory purposes. In practice, data structure 500 may include additional fields, fewer fields, different fields, and/or differently arranged fields than are described with respect to data structure 500.

Trial ID field 505 may store information that identifies a trial that produced the example outcome associated with data structure 500. Each trial may correspond to a different possible outcome. In other words, a quantity of trials may equal a quantity of the possible outcomes.

Item ID field 510, category field 525, number of units field 530, unit cost field 535, total cost field 540, unit price field 545, total price field 550 may include the same type of information as stored in item ID field 410, category field 420, number of units field 430, unit cost field 440, total cost field 450, unit price field 460, and total price field 470 of data structure 400 of FIG. 4, respectively. Customer ID field 515 and time period ID field 520 may include the same type of information as stored in customer ID field 320 and time period ID field 330 of data structure 300 of FIG. 3, respectively.

Trial total cost field 555, in data structure 500, may store information that identifies a total cost of all units of a particular item if the particular item/event occurs. Accordingly, a monetary value, stored in trial total cost field 555, may equal a corresponding monetary value stored in total cost field 540. Similarly, trial total price field 560 may store information that identifies a total price at which the entity will sell all of the units of the particular item to the customer if the particular item/event occurs. Accordingly, a monetary value, stored in trial total price field 560, may equal a corresponding monetary value stored in total price field 550. Each one of ellipses 572 and 574 may correspond to a different item of a particular event that occurred during a particular trial (e.g., a first trial).

For example, information associated with a first item of the particular event that occurred, may include, as shown in ellipse 572, an identifier of a first trial (e.g., T1) during which the particular event occurred, an identifier associated with a first item (e.g., I1), a customer identifier (e.g., B1) associated with the particular event, an identifier of a particular fiscal period (e.g., 2011Q4) associated with the particular event, a first category (e.g., C1) associated with the first item, a quantity of units (e.g., 3) that are sold of the first item when the first item occurs, a unit cost (e.g., $10.00) of each one of the units of the first item, a total cost (e.g., $30.00) of all of the units of the first item, a unit price (e.g., $15.00) of each one of the units of the first item, a total price (e.g., $45.00) of all of the units of the first item, a trial total cost (e.g., $30.00) when the first item occurs, and a trial total price (e.g., $45.00) when the first item occurs.

Information associated with a second item of the particular event that occurred, may include, as shown in ellipse 574, an identifier of the first trial (e.g., T1) during which the particular event occurred, an identifier associated with a second item (e.g., I2), a customer identifier (e.g., B1) associated with the particular event, an identifier of a particular time period (e.g., 2011Q4) associated with the particular event, a second category (e.g., C2) associated with the second item, a quantity of units (e.g., 2) that are sold of the second item when the second item occurs, a unit cost (e.g., $25.00) of each one of the units of the second item, a total cost (e.g., $50.00) of all of the units of the second item, a unit price (e.g., $30.00) of each one of the units of the second item, a total price (e.g., $60.00) of all of the units of the second item, a trial total cost (e.g., $50.00) when the second item occurs, and a trial total price (e.g., $60.00) when the second item occurs.

FIG. 5B illustrates a data structure 580, which is a portion of an example outcome, for items of an event that does not occur. Data structure 580 may be generated and/or used in the same way as data structure 500, as described above with reference to FIG. 5A. Furthermore, as shown in FIG. 5B, data structure 580 may include same type of fields as data structure 500. In practice, data structure 580 may include additional fields, fewer fields, different fields, and/or differently arranged fields than are described above with respect to data structure 500.

As shown in FIG. 5B, trial total cost field 555, in data structure 580, may store information that identifies a total cost of all units of a particular item when the particular item/event does not occur. Accordingly, a monetary value, stored in trial total cost field 555 of data structure 580, may be equal to zero when the event never happens and the entity does not incur any costs related to the event. Similarly, trial total price field 560 may store information that identifies a total price at which the entity may sell all of the units of the particular item to the customer when the particular item/event does not occur. Accordingly, a monetary value, stored in trial total price field 560 of data structure 580, may be equal to zero when the event never happens and the entity does not earn any money related to the event by selling items at their price.

Each one of ellipses 582 and 584 may correspond to a different item of a particular event that did not occur during a particular trial (e.g., a second trial). For example, information associated with a first item of the particular event that did not occur, may include, as shown in ellipse 582, an identifier of a second trial (e.g., T2) during which the particular event did not occur, an identifier associated with a first item (e.g., I1), a customer identifier (e.g., B1) associated with the particular event, an identifier of a particular time period (e.g., 2011Q4) associated with the particular event, a first category (e.g., C1) associated with the first item, a quantity of units (e.g., 3) that may be sold of the first item when the particular event occurs, a unit cost (e.g., $10.00) of each one of the units of the first item, a total cost (e.g., $30.00) of all of the units of the first item, a unit price (e.g., $15.00) of each one of the units of the first item, a total price (e.g., $45.00) of all of the units of the first item, a trial total cost (e.g., $0) when the first item does not occur, and a trial total price (e.g., $0) when the first item does not occur.

Information associated with a second item of the particular event that did not occur, may include, as shown in ellipse 584, an identifier of the second trial (e.g., T2) during which the particular event did not occur, an identifier associated with a second item (e.g., I2), a customer identifier (e.g., B1) associated with the particular event, an identifier of a particular fiscal period (e.g., 2011Q4) associated with the particular event, a second category (e.g., C2) associated with the second item, a quantity of units (e.g., 2) that may be sold of the second item during other possible outcomes when the particular event occurs, a unit cost (e.g., $25.00) of each one of the units of the second item, a total cost (e.g., $50.00) of all of the units of the second item, a unit price (e.g., $30.00) of each one of the units of the second item, a total price (e.g., $60.00) of all of the units of the second item, a trial total cost (e.g., $0) when the second item does not occur, and a trial total price (e.g., $0) when the second item does not occur.

### Example Statistical Representations

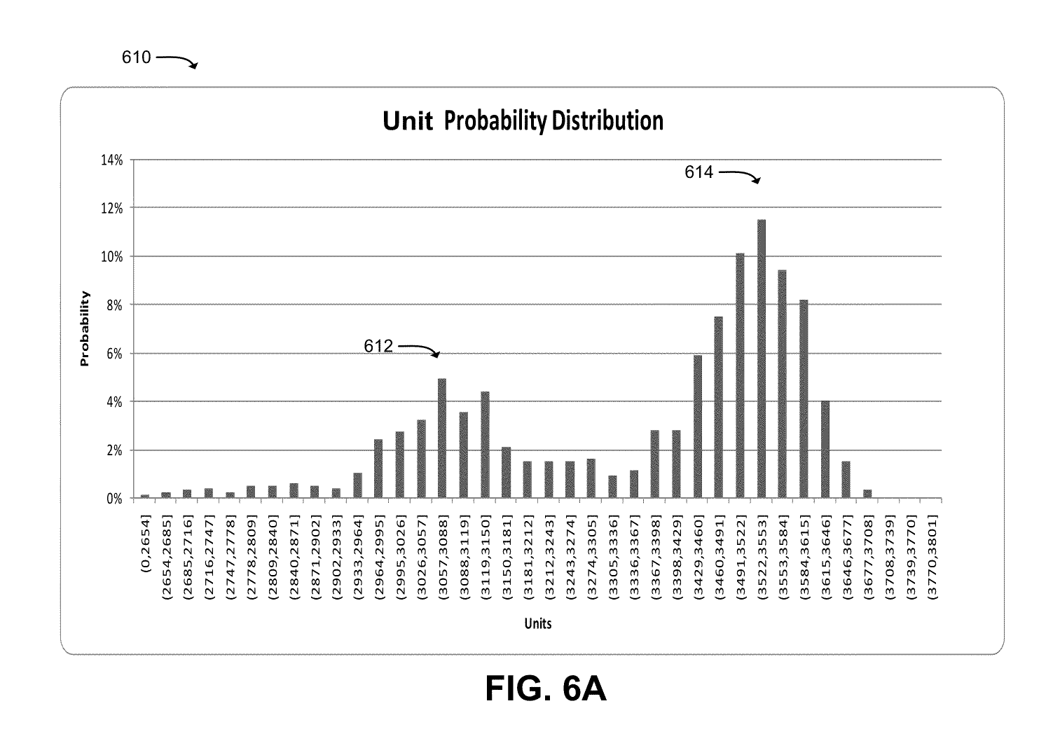

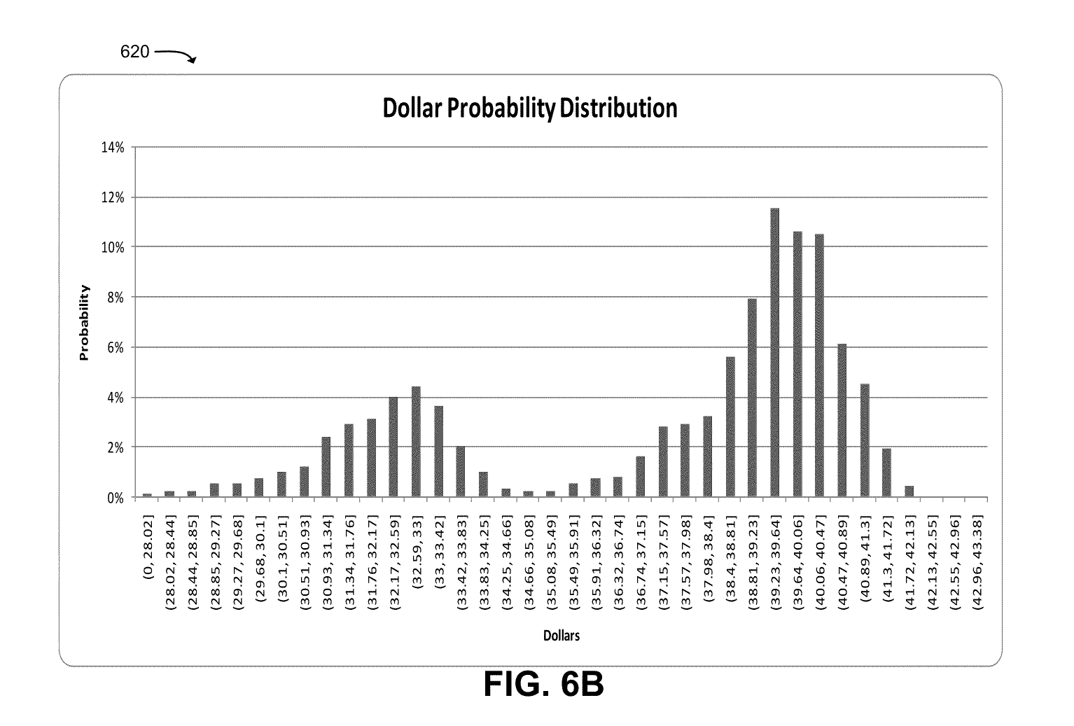

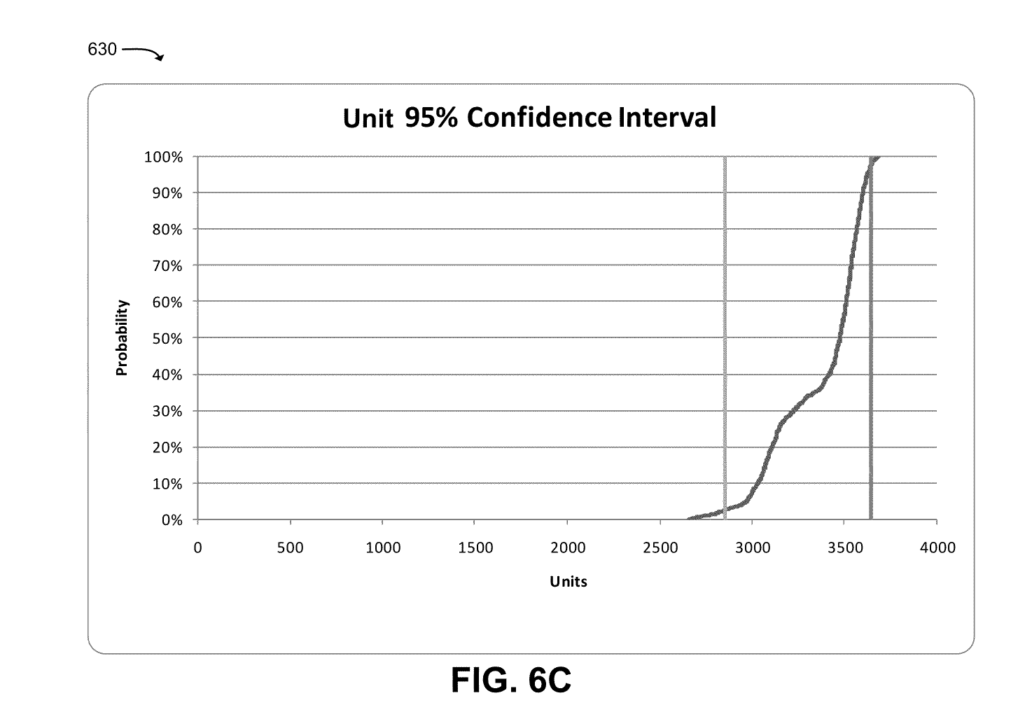

FIGS. 6A-6C are diagrams of example statistical representations that are generated for one or more particular items. Generator computer system 130 may retrieve data for one or more particular items from, for example, output storage device 140, which stores possible outcomes of events associated with the particular items. The data may only include a slice of information, of the possible outcomes, that is relevant to the particular items (and not to any other items associated with the events). Generator computer system 130 may generate the statistical representations, for the particular items, based on the data. The statistical representations may include, for example, a unit probability distribution chart, a dollar probability distribution chart, a unit confidence interval chart, and/or a dollar confidence interval chart.

FIG. 6A is a diagram of an example unit probability distribution chart 610. As shown in FIG. 6A, unit probability distribution chart 610 may include a vertical probability axis that represents a range of probabilities (e.g., 0%-14%) and a horizontal units axis that represents quantities of units of particular item(s). For example, unit probability distribution chart 610 illustrates that there is a 4% probability that between 3,615 and 3,646 units of the particular item(s) will occur.

As further shown in FIG. 6A, unit probability distribution chart 610 may include multiple spikes, such as a small spike 612 and a large spike 614. Large spike 614 may correspond to the tallest bar of unit probability distribution chart 610. The tallest bar indicates that the likeliest scenario (e.g., with about a 11.5% probability) is that between 3,522 and 3,553 units of the particular item(s) will occur. The tallest bar is surrounded, in a first high density area of, unit probability distribution chart 610, with other bars that indicate less likely scenarios.

Small spike 612 may correspond to a tallest bar of a second high density area of unit probability distribution chart 610. The tallest bar of the second high density area may indicate that if a quantity of the particular items that occurs does not fall within a range represented by one of the bars in the first high density area, then the likeliest scenario (e.g., with about a 5% probability) is that between 3,057 and 3,088 units of the particular item(s) will occur.

In one example, an entity associated with generator computer system 130, or a supplier, may use unit probability distribution chart 610 to plan to provide (e.g., to plan a production of and/or a sale of) a quantity of items that is within the first high density area or the second high density area. In another example, assume that at a certain point in time, the entity or the supplier determines that the quantity of the particular items that will occur is less than 3,367 (e.g., after determining that one or more of the particular events associated with the particular items do not occur). Based on unit probability distribution chart 610, the entity and/or the supplier may determine that a range of quantity of units of the particular items that will occur is within the second high density area, and is most likely represented by small spike 612.

FIG. 6B is a diagram of an example dollar probability distribution chart 620. As shown in FIG. 6B, dollar probability distribution chart 620 may include a vertical probability axis that represents a range of probabilities (e.g., 0%-14%) and a horizontal dollars axis that represents a total monetary value (e.g., total cost or price in millions of dollars) of units of the particular item(s). For example, dollar probability distribution chart 620 illustrates that there is a 4% probability that the total monetary value of units, of the particular item(s) that will occur, will equal between, for example, $32.17 million and $32.59 million.

FIG. 6C is a diagram of an example unit confidence interval chart. As shown in FIG. 6C, unit confidence interval chart 630 may include a vertical probability axis that represents a range of probabilities (e.g., 0%-100%) and a horizontal units axis that represents quantities of units of particular item(s) (e.g., 0-4000). FIG. 6C illustrates that there is a 95% chance that a quantity of units of the particular item(s) that will occur is equal to a number between about 2,800 and about 3,680. Based on unit confidence interval chart 630, the entity and/or the supplier may plan to order/provide between 2,800 and 3,680 of the particular item(s).

### Example Process

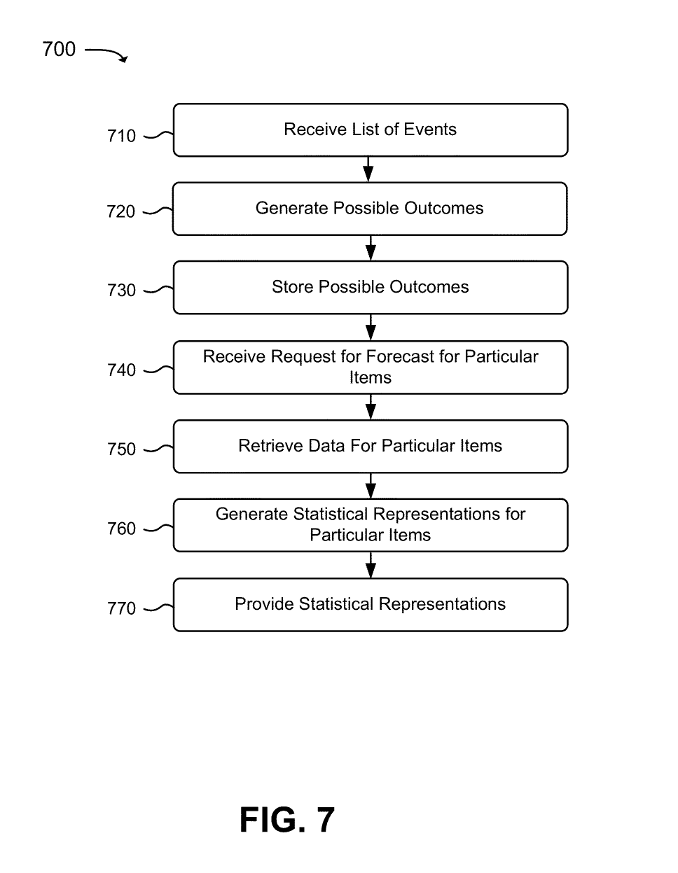

FIG. 7 is a flowchart of an example process 700 for using events data to provide information about particular item(s). In one implementation, generator computer system 130 may perform process 700. In another implementation, a device or collection of devices separate from, or in combination with, generator computer system 130 may perform some or all of process 700.

As shown in FIG. 7, process 700 may include receiving a list of events (block 710). For example, employees (e.g., sales people) of an entity may provide information about events. Each event may be associated with/include a probability (e.g., 50%) of the event occurring and a list of items. The employees may use a past history of the event and/or other information associated with the event to determine the probability. Multiple events may include one or more of the same items. Each item may represent a product that will be sold to a customer if one or more of the events, which are associated with/include the item, occur. Generator computer system 130 may receive a list of the events (e.g., data structure 300 of FIG. 3) from events storage device 120.

Process 700 may further include generating possible outcomes (block 720) and storing the possible outcomes (block 730). For example, generator computer system 130 may determine whether a quantity of the events is greater than a particular threshold (e.g., 10). When the quantity of events is not greater than the particular threshold, generator computer system 130 may generate all possible outcomes of the events based on probabilities associated with the events. For example, when the quantity of the events is equal to 4 (i.e., less than the particular threshold of 10) and each one of the 4 events has a probability of 50%, generator computer system 130 may generate all 16 possible outcomes. Each event may occur a total of eight times in the 16 possible outcomes.

When the quantity of events (e.g., 16) is greater than the particular threshold (e.g., 10), generator computer system 130 may generate a particular number of possible outcomes of the events. In one implementation, a user may provide the particular number during an initialization of generator computer system 130. In another implementation, generator computer system 130 may request for the user to provide the particular number before generator computer system 130 may generates the particular number of possible outcomes.

Generator computer system 130 may use a Monte Carlo simulation and/or one or more other types of computational algorithms to generate the different possible outcomes. Which events occur and which events do not occur vary between the different possible outcomes. Each one of the possible outcomes may include information (e.g., data structure 500 and/or data structure 580) that indicates which items occur when the corresponding events occur and which items do not occur when the corresponding events do not occur. For example, a first possible outcome, of the possible outcomes, may indicate that items associated with a first event do not occur and that items associated with a second event occur. A second possible outcome, of the possible outcomes, may indicate that items associated with a first event occur and that items associated with the second event occur. Generator computer system 130 may store the possible outcomes in output storage device 140.

Process 700 may also include receiving a request for a forecast for particular items (block 740). For example, a user (e.g., an employee of a supplier or the entity or requestor computer system 150) may plan for production of one or more particular items (e.g., pens and pencils) for a particular period of time (e.g., a particular fiscal period (e.g., 2011Q4)) in order for the entity to have enough of the particular items for potential sales when the sales occur. The user may enter a request (e.g., select) to receive a forecast for the particular items and the particular period of time. The request may include item identifiers (e.g., I1 and I2) that correspond to the particular items and information specifying the particular period of time.

Additionally, or alternatively, the user may select to receive the forecast limited to the particular items, the particular period of time, and/or one or more other parameters associated with the events/items. For example, the user may select to receive the forecast only for items that are sold to particular customer(s) and/or in a particular category or categories. The request may include identifiers that specify the other parameters (e.g., B1 and/or C1 and C2). Generator computer system 130 may receive the request from requestor computer system 150 or from a computer terminal connected to generator computer system 130 (e.g., user device 110).

Process 700 may also include retrieving data for the particular items (block 750). For example, generator computer system 130 may retrieve data from the generated possible outcomes based on the parameter selected by the user, which are specified in the request. In one example, the retrieved data may include information only for the particular items (e.g., the pens and the pencils) that may be needed by the entity during the particular period of time (e.g., 2011Q4). The particular items may be needed, for example, by the entity, from the supplier, to provide to customer(s) when potential events (e.g., sales) occur. The retrieved data may include information for/from each one of the generated possible outcomes. Generator computer system 130 may retrieve the data, for the particular items, from output storage device 140.

Process 700 may also include generating statistical representations for the particular items (block 760) and providing the statistical representations (block 770). In one implementation, generator computer system 130 may generate statistical representations (e.g., as shown in FIGS. 6A-6C) and/or one or more other types of metrics (e.g., a confidence interval, a median, etc.), for the particular items, based on the retrieved data. Generator computer system 130 may provide the statistical representations and/or the other types of metrics to requestor computer system 150 or another computer terminal that requested the forecast for particular items.

In another implementation, generator computer system 130 may provide the retrieved data to requestor computer system 150. Requestor computer system 150 may generate the statistical representations (e.g., as shown in FIGS. 6A-6C) and/or one or more other types of metrics (e.g., a confidence interval, a median, etc.), for the particular items, based on the retrieved data.

Thereafter, in one implementation, requestor computer system 150 may use the statistical representations and/or the other types of metrics to plan to produce or sell, to manufacture, and/or to provide the particular items to the entity. For example, requestor computer system 150 may use a unit probability distribution chart (e.g., probability distribution chart 610 of FIG. 6A) that includes two spikes in the distribution, including a smaller spike and a larger spike. Requestor computer system 150 may determine that if a particular event does not occur, which is necessary to achieve sales of units of the particular items in a range associated with the larger spike, then a sale of a quantity of units associated with the smaller spike is most likely. Therefore, after the particular event does not occur, requestor computer system 150 may ramp down to plan to produce or sell, to provide, and/or to manufacture the lower quantity of units, associated with the smaller spike, to the entity. In another implementation, a computer device associated with the entity may be used to place order(s), from the suppliers, for the particular items based on the statistical representations.

### CONCLUSION

One or more implementations, described above, may allow a computer device to use data about events, of an entity, to provide forecast information for only particular items associated with (e.g., included in) the events. The forecast information for only the particular items may be used, for example, to properly plan to acquire and/or supply a quantity, within a particular range, of the particular items. As a result, the entity can avoid wasting resources and/or missing sales opportunities due to lack of forecasts focused on, specifically, the particular items.

Furthermore, one or more implementations, described above, have a variety of applications, including, for example, financial analysis, engineering, etc. For example, assume that an investor uses net present value (NPV) as a metric in financial analysis to assess the value of a potential investment in a project. The project may be associated with multiple events, and the project and the multiple events may be associated with different types of items. The project may include, for example, building plants to manufacture different types of items and/or selling the different types of items.

A computer device, of the investor, may receive information about the project, including, for example, data needed to calculate an NPV for the project. The computer device may use a Monte Carlo simulation, and/or one or more other types of computational algorithms, to generate possible (i.e., simulated) outcomes based on the received information. Each possible outcome may include, for example, a set of cash flows and a corresponding NPV. Each cash flow, in one of the sets of cash flow, may indicate, for example, an amount of cash flow for a particular year based on whether a particular event occurs or does not occur. For example, a particular event may occur when an entity associated with a project gets a particular customer (e.g., Example Store) in a particular year (e.g., year 2017).

Thereafter, the computer device may receive a request to provide statistical representations (e.g., visualization of NPV distributions and/or other statistics) for only particular items associated with the project. The computer device may generate statistical representations for only the particular items based on portions (e.g., slices) of the possible outcomes associated with the particular items.

In one implementation, the computer device may provide (e.g., display or transmit) the statistical representations to the investor. The investor may use the statistical representations to make an investment decision regarding the project. For example, the investor may compare a 95% confidence interval of the project to a 95% confidence interval of another project). In another implementation, the computer device or the investor may feed the statistical representations into another computer device for the other computer device to provide investment advice regarding the project.

The foregoing description provides illustration and description, but is not intended to be exhaustive or to limit the possible implementations to the precise form disclosed. Modifications and variations are possible in light of the above teachings or may be acquired from practice.

Also, while a series of blocks has been described with regards to FIG. 7, the order of the blocks may be modified in other implementations. Further, non-dependent blocks may be performed in parallel.

It will be apparent that example aspects, as described above, may be implemented in many different forms of software, firmware, and hardware in the implementations illustrated in the figures. The actual software code or specialized control hardware used to implement these aspects should not be construed as limiting. Thus, the operation and behavior of the aspects were described without reference to the specific software code-it being understood that software and control hardware could be designed to implement the aspects based on the description herein.

Also, certain portions of the system implementations may be implemented as a “component” that performs one or more functions. These components may include hardware, such as a processor, an ASIC, or a FPGA, or a combination of hardware and software.

Even though particular combinations of features are recited in the claims and/or disclosed in the specification, these combinations are not intended to limit the disclosure of the possible implementations. In fact, many of these features may be combined in ways not specifically recited in the claims and/or disclosed in the specification. Although each dependent claim listed below may directly depend on only one other claim, the disclosure of the implementations includes each dependent claim in combination with every other claim in the claim set.

No element, act, or instruction used in the present application should be construed as critical or essential unless explicitly described as such. Also, as used herein, the article “a” is intended to include one or more items. Where only one item is intended, the term “one” or similar language is used. Further, the phrase “based on” is intended to mean “based, at least in part, on” unless explicitly stated otherwise.

What is claimed is:

1. A method comprising:
receiving, by a computer device, information about events,
where each event, of the events, is associated with one or more of a plurality of items that occur when the event occurs;
generating, by the computer device, possible outcomes of the events based on the information;
receiving, by the computer device, a request for a forecast for only one or more selected items of the plurality of items;
retrieving, by the computer device, data, for only the one or more selected items, from the possible outcomes;
generating, by the computer device, the forecast for the one or more selected items based on the data; and
providing, by the computer device, the forecast to an entity associated with the events or to a supplier of the one or more selected items.

2. The method of claim 1,
where one of the events represents a potential sale to a customer, and
where one of the plurality of items represents a product sold to the customer by the entity when the one of the events occurs.

3. The method of claim 1,
where the information about the events comprises one or more of:
an identifier corresponding to a customer associated with an event of the events, or
a period of time associated with the event,
where the request further specifies at least one of the customer identifier or the period of time, and
where the forecast is further associated with at least one of the customer identifier or the period of time.

4. The method of claim 1,
where the information about the events comprises probabilities of the events occurring, and
where generating the possible outcomes comprises:
using a Monte Carlo simulation to generate at least one of the one or more possible outcomes based on the probabilities.

5. The method of claim 1, where generating the possible outcomes comprises:
determining a quantity of the events,
determining whether the quantity is less than a threshold,
generating all possible outcomes of the events, as the possible outcomes, when the quantity of the events is less than the threshold, and
generating a particular number of events when the when the quantity of the events is not less than the threshold.

6. The method of claim 1, where each one of the possible outcomes indicates which ones of the events occur and which ones of the events do not occur

7. The method of claim 1,
where one of the possible outcomes comprises a set of cash flows, and
where a cash flow, in the set of cash flows, comprises an amount of cash flow, for a particular period of time, when one of the event occurs.

8. The method of claim 1,
where the forecast comprises one or more statistical representations,
where the one or more statistical representations comprise one or more of:
unit probability distribution information that specifies quantities of the one or more selected items when one or more of the events occur,
dollar probability distribution information that specifies a monetary value associated with the one or more selected items when one or more of the events occur, or
confidence interval information that specifies, with a particular percentage of confidence, a range of possible quantities of the one or more selected items when one or more of the events occur.

9. A device comprising:
a memory to store instructions; and
a processor, to execute one or more of the instructions to:
receive information associated with a plurality of events,
where a first event, of the events, comprises:
a first item, and
a second item, and
where a second event, of the plurality of events, comprises:
the first item, and
one or more third items,
where the first item is different from the second item, and
where the one or more third items are different from the first item and the second item,
generate possible outcomes of the plurality of events based on the information, receive a request for a forecast for one or more selected items,
where the one or more selected items comprise a selection of the first item, retrieve data, for only the one or more selected items, from the possible outcomes, generate the forecast, for the one or more selected items, based on the data, and use the forecast to generate a plan to provide the one or more selected items.

10. The device of claim 9, where the forecast comprises information about a sale of the first item to one or more customers by an entity when at least one of the first event or the second event occurs.

11. The device of claim 9,
where the information associated with the plurality of events comprises:
a first probability of the first event occurring during a particular period of time, and
a second probability of the second event occurring during the particular period of time, and
where, when generating the possible outcomes, the processor is to:
generate the possible outcomes based on the first probability and the second probability.

12. The device of claim 9, where the possible outcomes comprise one or more of:
a first possible outcome when the first event occurs and the second event occurs,
a second possible outcome when the first event occurs and the second event does not occur,
a third possible outcome when the first event does not occur occurs and the second event occurs, or
a fourth possible outcome when the first event does not occur occurs and the second event does not occur.

13. The device of claim 9, where the forecast comprises one or more of:
information that specifies quantities of the one or more selected items when one or more of the plurality of events occur,
information that specifies a monetary value associated with the one or more selected items when one or more of the plurality of events occur, or
information that specifies, with a particular percentage of confidence, a range of possible quantities of the one or more selected items when one or more of the plurality of events occur.

14. The device of claim 9, where, when using the forecast to generate the plan to provide the one or more selected items, the processor is to:
generate an order for the one or more selected items based on the forecast, and
transmit the order to a supplier of the one or more selected items.

15. One or more non-transitory computer-readable media comprising:
instructions, which when executed by one or more processors of a computing device, cause the one or more processors to:
receive a list of events,
generate possible outcomes of the events, where each one of the possible outcomes indicates which ones of the events occur and which ones of the events do not occur,
receive a request for forecast information for an item associated with two or more of the events,
retrieve data, from the possible outcomes, for the item,
generate the forecast, for the item, based on the data, and
use the forecast to generate a plan to provide or to provide the item or a product associated with the item.

16. The media of claim 15,
where the list of the events comprises probabilities of the events materializing, and
where, when generating the possible outcomes, the instructions cause the one or more processors to:
generate the possible outcomes based on the probabilities.

17. The media of claim 15,
where the forecast comprises one or more statistical representations,
where the request is received from a supplier of the item,
where, when using the forecast, the instructions cause the one or more processors to:
transmit the statistical representations to the supplier.

18. The media of claim 15,
where one of the events represents a potential sale to a customer, and
where the item represents a product provided to the customer when the potential sale occurs.

19. The media of claim 15,
where one of the possible outcomes comprises a set of cash flows, and
where a cash flow, in the set of cash flows, comprises an amount of cash flow, for a particular period of time, when one of the event occurs.

20. The media of claim 15, where the forecast comprises one or more of:
information that specifies quantities of the item when one or more of the events occur,
information that specifies a monetary value associated with the item when one or more of the events occur, or
information that specifies, with a particular percentage of confidence, a range of possible quantities of the item when one or more of the events occur.
